(19) United States
(12) Patent Application Publication
(10) Pub. No.: US 2007/0061265 A1
(43) Pub. Date: Mar. 15, 2007

(54) A SYSTEM AND METHOD FOR THE PROVISION OF AUDIO AND/OR VISUAL SERVICES

(75) Inventors: Shant Hovnanian, New York, NY (US); Christopher Vizas, Washington, DC (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Speedus Corp., New York, NY (US)

(21) Appl. No.: 11/276,920

(22) Filed: Mar. 17, 2006

Related U.S. Application Data
(60) Provisional application No. 60/662,641, filed on Mar. 17, 2005.

(51) Int. Cl. G06Q 99/00

(52) U.S. Cl. 705/51

(57) ABSTRACT

A content management device for moving digital audio and/or visual content to the edge of a network so that it is available in a controlled way, while avoiding bandwidth limitations. The device has a removable digital storage unit and appropriate control circuitry including a content fetcher module and an end-user communications module. The device may be preloaded, for example, with 100-200 full-length, securely encrypted motion pictures from a main content storage, then physically transported to a location at or near to an end-user. Conditional access to the content may be provided via suitable licensing arrangements such as for a limited time, a fixed amount of content or a predetermined rate of content use, or some combination thereof. The device decrypts end-user selected content and may digitally watermarking the content before distribution to the end-user. The device may automatically destroy the content if redistribution authorization expires or is otherwise found to be invalid.

### CROSS REFERENCE TO RELATED APPLICATIONS

This application is related to and claims the priority of U. S. Provisional Application Serial No. 60/662,641 entitled “A System and Method for the Provision of Audio -Visual Services” filed on Mar. 17, 2005, the entire contents and substance of which are incorporated in total by reference.

### FIELD OF THE INVENTION

The present invention to the storage and distribution of digital video content, and particularly to distribution of large volumes of securely managed digital video content.

### BACKGROUND OF THE INVENTION

Copyright owners of audio content, particularly music, have had a difficult time controlling distribution of digital versions of their content and collecting appropriate fees or royalties for the use of their content. These problems have been due to a number of factors, including the fidelity of digital copies, peer-to-peer file sharing software and the availability of data distribution networks such as the Internet. These have allowed end-users to distribute the audio content with total disregard for royalty, or other licensing fee, payments to the copyright holders.

As broadband network connections become more widely available, copyright holders of video content, such as motion picture, are concerned that they will face similar problems.

At the same time, both the video copyright holders and broad-band internet providers would like to realize the potential advantage of more directly distributing the video content to end users, including bypassing traditional video distribution systems such as television networks and so obtaining a greater share of any fees collected.

In particular, holders and providers would like to supply consumers with substantial quantities of content (e.g., hundreds of hours of video content) in a flexible, reliable and reusable manner.

### SUMMARY OF THE INVENTION

Briefly described, the invention provides a method and apparatus for moving digital audio and/or visual content closer to the edge of the network, and in some embodiments, even off the network and located at the end-users site. In this way, broadband audio and/or visual content can be made available to end users in a controlled way, while avoiding the bandwidth limitations of existing networks.

In a preferred embodiment of the invention a content manager includes a secure digital storage module that may be removable, and the appropriate control circuitry that may include a content fetcher module and an end-user communications module. The digital storage module may, for instance, be preloaded with digital audio and/or visual content from a main store of content at a central server location, and then be associated with a content manager by being physically transported to the location of the content manager, which may be at an end-user's premise or at some suitable nearby location.

The term audio and/or visual content is intended to cover all forms of information that may be stored digitally including, but not limited to, data, text, graphics, voice, music, video and photographic images, either individually or in any combination.

The secure digital storage module is preferably capable of storing a significant amount of content such as, but not limited to, 100-200 full length motion pictures stored at digital video disc (DVD) resolution, with suitably secure encryption. The content manager is capable of providing conditional access to these motion pictures to end-users via suitable licensing arrangements. Such licensing arrangements may cover both the content provider's relation to the content copyright holder, and the end-users relation to the content provider. The conditional access may, for instance, be for a limited time, for a fixed amount of content or for a predetermined rate of content use, or some combination thereof. The conditional access would include decrypting the content and may additionally include digitally watermarking the content before distribution. The conditional access may also include automatic destruction of all or part of the content on the storage device, with the destruction being automatically triggered by a date or event, unless the conditional access is specifically renewed prior to the date or event.

In further embodiments, the content on the secure digital storage module may be updated by methods such as, but not limited to, adding or replacing material via a physically storage medium that is physically transferred to an end-user or via secure transport over a network.

These and other features of the invention will be more fully understood by references to the following drawings.

### BRIEF DESCRIPTION OF THE DRAWINGS

FIG. 1 is a schematic view of an exemplary system for providing audio and/or visual services.

FIG. 2 is a flow diagram of an exemplary method for providing audio and/or visual services.

FIG. 3 is a cross-sectional plan view of a container for a content manager having a pressure activated decrypt key destruction attachment.

FIGS. 4A and B are cross-sectional elevation of a pressure activated deactivator in a closed and an open position.

### DETAILED DESCRIPTION

The present invention relates to methods, systems and apparatus for storing, managing and distributing digital audio and/or visual content.

Internet service providers (ISP), video content websites, as well as other owners and providers of audio and/or visual content, find it highly desirous to provide image rich, digital content such as, but not limited, digital video content to their customers, but are restrained by network bandwidth limitations and piracy concerns. One solution to this dilemma is to move the content closer to the edge of the network by providing multiple robust, managed secure digital storage module remote from central servers and close to the end-user in a secure manner. In certain embodiments, the content is even moved off the network and located at the end-user's premises. The secure digital storage module may be part of a personal computer (PC), a server, or any other devices that permit digital storage, including upgrading, removal, replacement, refreshing and enhancement through, for instance, but not limited to, any packet based communications. The secure digital storage module may also be a virtual device within a PC, an attachment to a PC or an attachment to a television or other video display mechanism. A preferred embodiment of the present invention provides such a digital media device, as described in detail below by reference to the attached drawings in which, as far as possible, like numbers refer to like elements.

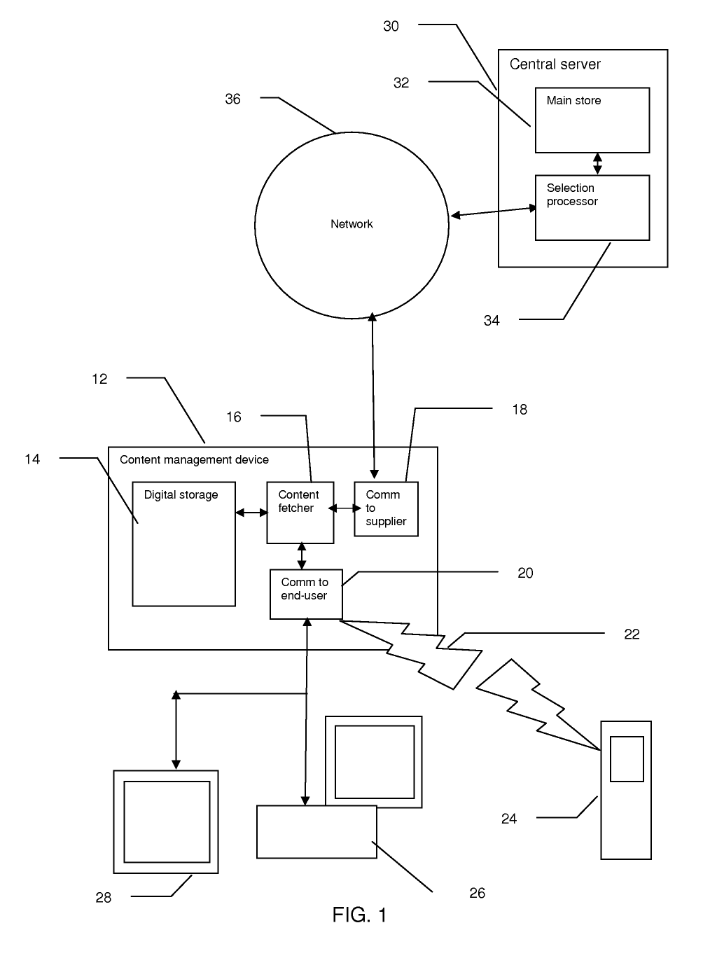

FIG. 1 is a schematic view of an exemplary system for providing audio and/or visual services, comprising a content manager 12, and central server 30, a network 36, a video display tablet 28, a personal computer and monitor 26 and a wireless telephone 24. The content manager 12 comprises a removable secure digital storage module 14, a content fetcher module 16, an end-user communications module 20 and a supplier communications module 18. The central server 30 comprises a main store 32 and a selection processor 34.

In a preferred embodiment, the secure digital storage module 14 may be a large, removable digital storage device such as, but not limited to, a 500 GB removable hard drive capable of storing 100- 200 full length motion pictures, including the related audio content. The motion pictures may, for instance, each be stored as separate digital files and may each have one or more independent encryption keys. There may also be a combination of individual keys and grouped encryption keys. The secure digital storage module 14 is preferably removable from a content management device 12, which may be, for instance, comprise a ruggedised electronics housing and associated file management and communications electronic circuitry.

The content fetcher module 16 may, for instance, be a general purpose microprocessor programmed to manage the stored digital content, including managing cataloging of the content, selection of the content, checking on the authorization of the end-user to view or otherwise have access to the content, decrypting of the content and sending the content to the end user. The content fetcher module 16 may be capable of dealing with content encoded in a variety of standard digital formats including, but not limited to, internet protocol (IP), MPEG, JPEG other standardized formats. The content fetcher module may also be programmed to be capable of dealing with movies, television shows and other audio and/or visual productions in their native format such as, but not limited, NTSC and PAL video. The content fetcher 16 may also be programmed to act as a media player or video card. The content fetcher may also be programmed to perform periodic checks on the validity of a redistribution license for the content stored on the digital storage 14, and be capable of deleting, locking or freezing the stored content if the license has expired or has not been actively renewed before a predetermined date. Such content deleting is preferably accomplished by overwriting the entire content with new, preferably random data. Content locking is preferably accomplished by deleting decryption keys required to decrypt the content with the invalid or expired redistribution authorization. Content freezing is preferably accomplished by the content fetcher 16 refusing access to the content with the invalid or expired redistribution authorization. The content fetcher 16 may also be programmed to constantly check if the physical integrity of the digital storage area has been breached, and if it has, respond by, for instance, immediately destroying any decryption keys that are necessary to decrypt the stored data, and then by attempting to overwrite the data if possible. The content fetcher 16 may be capable of interpreting any content registry and menus which classify the content. The content fetcher may also provide means for the end-user (also known as “the customer”) to reclassify and categorize the content stored on the digital storage device 14. The content fetcher 16 may also be programmed to add appropriate digital water-marks to the content after decryption and prior to sending to the customer, so that content may be tracked if it is used illegally.

The end user communications module 20 enables the content management device to communicate with a variety of end-users devices such as, but not limited to a video tablet 28, a personal computer 26 or a wireless telephone with display screen 24. Other end-user devices that may be used to interact with the secure digital storage module 14 include, but are not limited to, an external media player, an external video card, a DVD player, a CD ROM player or a television.

A content manager 12 may be associated with a single end-user (also known as “a customer”) or it may be associated with a group of customers.

The communications between the content manager 12 and the end-user devices may be by any suitable means such as, but not limited to, a conventional direct connection such as a landline, a cable television line, a fiber optic line, a LAN connection or a broadband IP connection, or the connection may be by a wireless link, such as, but not limited to, a cellular phone network, a WiFi network, a broadband wireless IP connection or any digital connection.

The communications to supplier module is an optional module which may allow the content manager 12 to communicate with a central server 30 over a suitable network 36 for purposes such as, but not limited to, providing status updates, updating licensing authorizations and downloading content or encryption keys.

The central server 30 is an optional central site where content is warehoused. The removable secure digital storage module 14 may, for instance, be preloaded with content at a central site bay direct connection to the main store 32 via the selection processor 34.

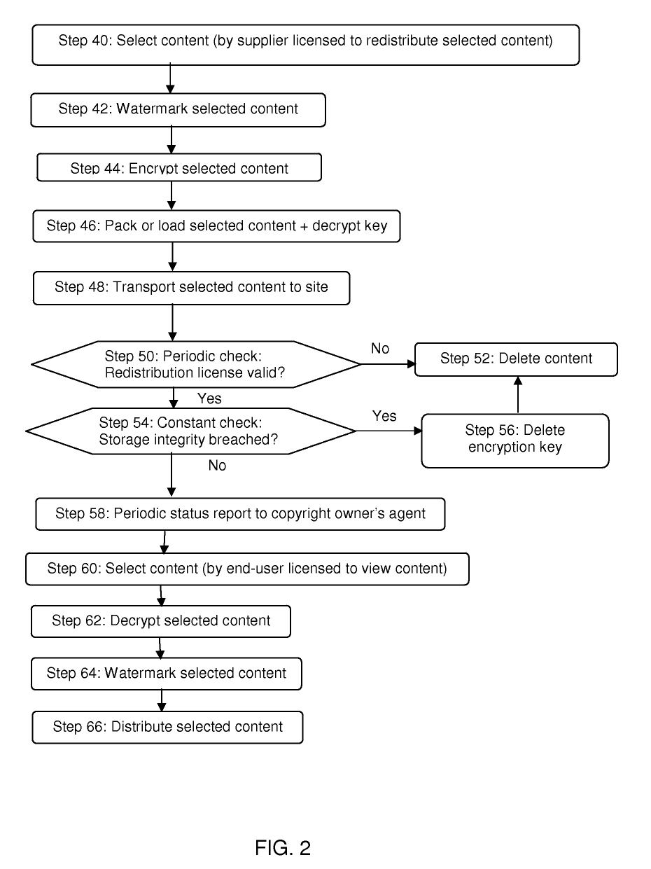

FIG. 2 is a flow diagram of an exemplary method for providing audio and/or visual services.

In a preferred embodiment, a supplier such as but not limited to, an Internet Service Provider (ISP) who has obtained a suitable license or other permission for a copyright owner, selects content in step 40. This content selection may, for instance, take the form of selecting titles from a menu or opting for a pre-selected batch of 100- 200 movies, videos or game titles. Once the content is selected, it may be watermarked in step 42 by a suitable digital watermarking technique so that, in the event of any illegal distribution of the content, there is an audit trail leading back to the source of the illegally distributed content. Digital watermarking is well-known and described in, for instance, U.S. Pat. No. 7,006,661 issued to Miller et al. on Feb. 28, 2006 entitled “Digital watermarking systems and methods”. The selection may also, for instance take place via an Internet presented menu, a pre-printed paper menu or via pre-selected categories.

In step 44 the watermarked content is then encrypted by any suitably secure digital encryption technique, and packed or loaded onto the digital storage device in step 46. Secure digital encryption is well-known and described in, for instance, U.S. Pat. No. 6,807,633 issued to Pavlik on Oct. 19, 2004 entitled “Digital signature system”, the entire contents of which are hereby incorporated by reference. The decryption key may be loaded on the digital storage device or sent separately to the content management device. In one embodiment of the invention, the decryption key is loaded on a volatile memory that is part of the removable secure digital storage module 14. The digital storage device 14 is further configured so that if its physical integrity is breached in any way, the volatile memory loses power and the encryption key is automatically lost. In such a configuration the entire contents of the secure digital storage module 14 may be encrypted with a single key, i.e. the encryption envelope encompasses the contents of the entire digital storage device and the individual content elements are not each encrypted separately. It is also possible that any of a range of other digital rights management technologies ad techniques may be employed to protect the content of the entire device or of particular copyrighted material within the device.

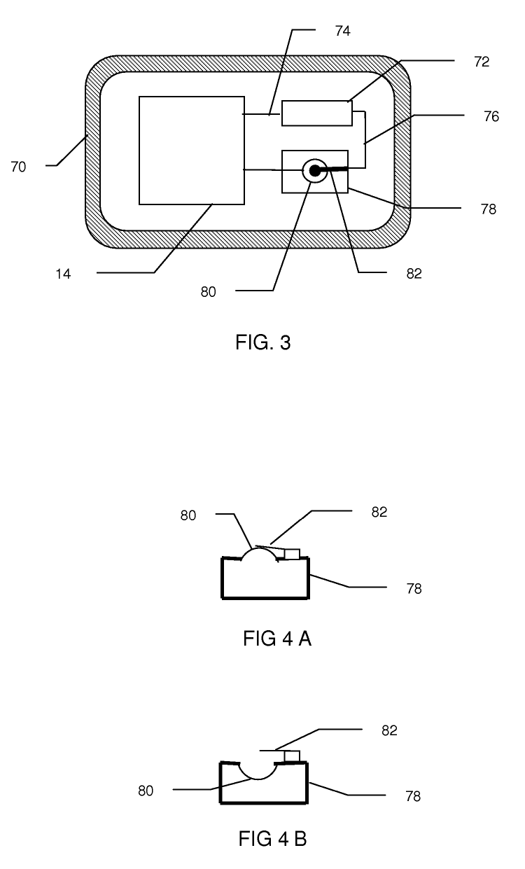

An exemplary container 70 for secure digital storage module 14 having a pressure activated decrypt key destruction attachment is shown in FIG. 3. The secure digital storage module 14 is sealed in the container 70 under a vacuum or a pressure that is significantly less than atmospheric pressure along with a battery 72 and a pressure sensitive electronic switch 78. One terminal of the battery 72 that is used to power a volatile memory such as, but not limited to a CMOS memory, containing the decryption key, may be connected directly to the digital storage device 14 via connector 74. The other terminal of the battery 72 is connected to the digital storage device 14 via the pressure sensitive switch 78 via connecter 76. An exemplary pressure sensitive switch 78 may comprise a suitably shaped flexible conducting membrane 80, such as, but not limited to, a circular gold coated rubber membrane, covering an aperture in a pressure tight container. The pressure in the switch 78 may be atmospheric pressure or less but significantly more than the pressure under which the container 70 is sealed. Once container 70 is sealed, the pressure sensitive switch is in the ON configuration, depicted in elevational cross-section in FIG. 4A. Because the pressure in the switch 78 is higher than the pressure in the rest of container 70, the flexible conducting membrane 80 bows outward and makes contact with sprung metal contact 82. In this configuration, current flows from the battery 72 to the volatile memory in the digital storage device 14 that contains the decrypt key. If, however, the integrity of the container 70 is breached, air enters the container, raising the pressure. The flexible membrane no longer bows outward. If the pressure in the switch 78 is significantly less than atmospheric pressure, the flexible, conducting membrane 80 bows inwards, as depicted in elevational cross-section in FIG. 4B and contact 82 no longer touches the flexible, conducting membrane 80. In this OFF state, current from battery 72 can no longer maintain the state of the volatile memory containing the decrypt key. In this way the decrypt key is destroyed as soon as the container 70 is breached.

In step 48, the selected content is transported to the site, i.e. in a preferred embodiment; the secure digital storage module 14 is associated with the content manager 12 by being physically transported to the location of the content manager 12. The content manager 12 may for instance, be located at the end-user's premises or home, where it may be linked to one or more display terminals such as televisions, computers or personal digital assistants (PDA). In such a case, the secure digital storage module 14 may, for instance be sent by mail. In the instances when the content manager 12 is situated at a location that is not an address reachable by mail, such as when it is an equipment utility closet in a multi-tenant building, on an electricity supply pole, or a telecom pole or at a sub-transformer site, the secure digital storage module 14 may be delivered by a technician or courier who also installs it in content management device 12. The content manager 12 may also be located at a cable distribution junction, a telecom substation, a telecom SIP stack or at an electrical substation. In the case of the electrical substation, case the secure digital storage module may, for instance, be mailed to a technical center responsible for routine maintenance of the equipment and installed by a technician as part of the routine maintenance of the other equipment.

In an alternative embodiment of the invention, the secure digital storage module 14 may be associated with the content manager 12 at, for instance, a central location and they may be transported to the end user's location as a package.

Once the secure digital storage module 14 is associated with the content manager 12, the content fetcher may take step 50 of periodically checking if a redistribution license is still valid. This may be as simple as checking if a certain time has expired since the secure digital storage module 14 was attached, or may involve checking a current date against an expiry date stored in the digital storage device 14. If a preferred embodiment, if the content fetcher 16 ascertains that the redistribution license or other form of authorization has expired, the content fetcher will go to step 52 and delete the content of the secure digital storage module 14 by physically over-writing the storage, preferably with random or pseudo-random data. The deletion may begin by over-writing the encryption key first so as to make the stored content inaccessible as soon after detecting the lack of authorization. Such monitoring authorization may take the form of the content being destroyed after a preset time or event, unless specifically instructed not to.

In an alternative embodiment of the invention, if the content fetcher 16 ascertains that the redistribution license or other form of authorization has expired, the content fetcher may lock the material by, for instance, deleting the decryption codes required to access the content with the expired or invalid redistribution authorization.

In a further alternative embodiment of the invention, if the content fetcher 16 ascertains that the redistribution license or other form of authorization has expired, the content fetcher may simply freeze the material by, for instance, not accessing the content with the expired or invalid redistribution authorization.

Step 54 of constantly checking to see if the storage integrity has been breached may take the form of having a pressure sensitive device incorporated in the secure digital storage module 14, as detailed above, and if the integrity is breached, the device may move to step 56 and immediately destroy the encryption key, as detailed above. The content fetcher 16 may also take detecting a destroyed encryption key as a signal to go to step 52 and delete the content of the digital storage device, preferably by overwriting the data with random or pseudo-random data.

In step 58, the content fetcher may make use of a supplier communications module 18 to send a status and/or usage report to the copyright owner or the copyright owner's agent. In the absence of a suitable communications module or link, this report may be dated and stored on the digital storage device for later retrieval.

In step 60, an end-user selects content that they desire to download from the secure digital storage module 14. As part of the selection process, the content fetcher module 16 may also verify that the end-user is authorized or licensed to download the content they are requesting. Such authorization may, for instance, take the form of having bought the right, having paid a fee for the right, or may be of having paid an annual or other periodic licensing fee.

In step 62, the content fetcher decrypts the selected content using, for instance, the encryption key stored in volatile memory.

In step 64, the content fetcher may add a further digital watermark to the selected content which may be indicative of, for instance, the time the content is being downloaded, the identity of the secure digital storage module 14, the content has been stored in, the identity of the content fetcher 16 doing the downloading and the identity of the end user downloading the content. The digital watermark may, for instance, be steganographically hidden any images being downloaded as part of the content. Steganographic techniques are well known and described in, for instance, U.S. Pat. No. 6,449,367 issued to Van Wie et al. on Sep. 10, 2002 entitled “Steganographic techniques for securely delivering electronic digital rights management control information over insecure communication channels”, the entire contents of which are hereby incorporated by reference.

In step 66, the content is distributed to the end user for viewing or other use. Such use many include displaying content on one or more monitors simultaneously. Such use may also include simultaneously displaying different content on different screens such as, but not limited to, displaying different movies on different TV screens at the same time.

In further embodiments of the invention, the end-user may access the secure digital storage module 14 through other conditional access means such as, but not limited to, predefined time periods. The end-user may be subject to any suitable form of digital rights management such as, but not limited to, a time limited license, a volume limited license, a rate limited license, or a license limited by some combination of any or all of these.

In a further embodiment of the invention, the secure digital storage module 14 may itself contain a clock and a microprocessor, and may be preprogrammed to destroy or erase the data or content stored on the digital storage device at a predetermined time. In a further embodiment, the content erasure may, however, be avoided or postponed to a later time, by suitable update authorization. In one embodiment of the invention, the update date may be incorporated as a steganographically embedded watermark in one or more images associated with the content. Any file associated with a non-valid updated date i.e., an update date range that does not include the current date because the current date is either too early or too late, may be prevented from being exported out of the secure digital storage module 14 by a suitably programmed microprocessor on the storage device. This would, for instance, allow the contents rights holders to preload the storage devices 14 with content that would only become available at a later, predetermined release date, and which might then only be available for a limited time after that release date. In a further embodiment, the pre-release date is encoded as a code word rather than a date, and only when the code word is made available to, for instance, the content fetcher, either by the end user or from the central server via the network 36, will the content become available for downloading. In this way content could be preloaded and the release date determined after preloading of the content. Such release dates may also be geographically specified either by zip code or GPS input associated with an end-user device.

Although the embodiments above have been described by reference to a system in which the content is licensed and there is no passage of title from the copyright holder, the system may also use lease or rental arrangements in which no license is transferred or the system may use a system in which the title to one or more of the hardware elements of the system is passed on by sale, but title to the content or to one or more of the software components of the system, is not.

In a further embodiment of the invention, the initially stored content may be provided at a pre-established price and additional content may be added by the provider for an additional payment. Additional content, selected by the end-user, may be added from the central server on, for instance, a per byte or a per production basis.

In a further embodiment, content may be changed, in whole or in part by the provider on a periodic or quasi-periodic basis. The content may be changed by, for instance, transferring the replacement or additional material in appropriately secure, encrypted digital form, from the central server main store 32 over the network 36. In making the transfer, the network connection, which may for instance be a broadband IP connection, may be initiated by either the end-user or the supplier. In an alternative embodiment, an updated digital storage device 14 may be delivered to the end-user via courier or the mail system. Alternatively, the end-user may collect an updated digital storage device 14 from a distribution node, or location designated by the provider of the content.

In further embodiments, the customer may request a change in content on a periodic or quasi-periodic basis as, for instance, part of a subscription agreement or arrangement. Alternatively a request for a change of content may be made on an individual basis by a request to the service provider.

In further embodiments, payments for content may provide an end-user conditional access to the content for a stated period, or set of periods, at the end of which the end user losers the conditional access right.

In further embodiments, changes to the content stored on the digital storage device may be made at any time by means of an IP or other packet delivery system such as, but not limited to, the internet, a proprietary network, or the Public Switched Telephone Network (PSTN).

Changes to the content stored on the digital storage device may also be made by means of a storage medium, containing new content and content change instructions that are sent to the end-user by mail or a private courier or delivery service. Such content may then be loaded by the customer or end user. Such a storage medium could also be picked up at the content provider's premises or at some convenient third party location.

In further embodiments, the digital storage device may be operated by remote control that may incorporate ear phone connections or be incorporated into ear phones.

In a further embodiment of the invention, content management may be done via a content manager that is a software module running on the storage device. In such an embodiment, the storage device may be transported to the end-user and plugged directly into a player. Authorization for playing content may then be obtained by the player from a central location via a network, such as the internet.

In a further embodiment of the invention described immediately above, the player may also be on or physically associated with the storage device, and the entire assembly including storage device, content manager and player may be transported to the end user. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed:

1. A method of providing audio visual content, said method comprising the steps of:
loading encrypted digital content and a redistribution authorization onto a secure digital storage module;
associating said secure digital storage module with a content manager;
supplying said content manager with a decryption key;
checking said redistribution authorization by said content manager and, if not valid, automatically deleting, locking or freezing said content on said secure digital storage;
decrypting, by said content manager, content selected by an end user; and
distributing, by said content manager, said decrypted, selected content to said end user.

2. The method of claim 1 wherein said step of loading further comprises loading said decryption key on said secure digital storage module, and further comprising the steps of:
monitoring the integrity of said storage device and if the integrity of said secure, portable digital storage is breached, deleting said encryption key from said storage device.

3. The method of claim 2 wherein said encryption key is stored on a volatile memory, and wherein said step of monitoring further comprises, if the integrity of said secure, portable digital storage is breached, deleting said content from said storage device after said deleting said encryption key.

4. The method of claim 3 wherein said deleting said content comprises writing substantially random data over said content.

5. The method of claim 1 further comprising steganographically embedding a watermark in said digital content prior to encrypting said encrypted digital content.

6. The method of claim 5 wherein said watermark comprises said redistribution authority.

7. The method of claim 6 wherein said redistribution authority comprises a first date prior to which said content may not be distributed to an end user.

8. The method of claim 7 wherein said redistribution authority further comprises a second date after which said content may not be distributed to an end user.

9. The method of claim 8 wherein said step of checking determines said redistribution authority to be invalid if a current date of checking exceeds said second date and said step of automatically deleting said content from said secure digital storage module is implemented;

10. The method of claim 9 wherein said secure digital storage module has a capacity of at least 500GB.

11. The method of claim 1 wherein said encrypted digital content comprises a plurality of digital files and wherein each digital file has a distinct encryption key.

12. The method of claim 11 further comprising the step of stegographically embedding a watermark into said digital content by said content manager, subsequent to said decrypting and prior to said distributing.

13. A system for providing audio visual content, said method comprising:
a secure digital storage module containing encrypted digital content and a redistribution authorization;
a content manager for receiving said secure digital storage module and a decryption key; said content manager comprising:
a content fetcher module comprising a redistribution authorization checking unit; a content deletion unit responsive to authorization checking unit determining said redistribution authorization to be invalid; and a decryption module for decrypting content selected by an end user; and
a communications module for distributing said decrypted, selected content to said end user.

14. The system of claim 13 wherein said secure digital storage module further comprises a volatile memory containing said decryption key, and a integrity monitoring module for monitoring the integrity of said storage device and for deleting said encryption key and for deleting said content writing substantially random data over said content if the integrity of said storage device is breached.

15. The system of claim 14 wherein said redistribution authority comprises a stegographically embedded watermark in said digital content.

16. The system of claim 15 wherein said redistribution authority comprises a first date prior to which said content may not be distributed to an end user and s a second date after which said content may not be distributed to an end user and wherein said authorization checking unit determines said redistribution authority to be invalid if a current date of checking exceeds said second date and said content deletion unit automatically deletes said content from said secure digital storage module.

17. The system of claim 16 wherein said secure digital storage module has a capacity of at least 500 GB and said encrypted digital content comprises a plurality of digital files and wherein each digital file has a distinct encryption key.

18. The system of claim 17 wherein said content fetcher module further comprises a watermarking unit for stegographically embedding a watermark in said digital content prior to said decrypted, selected content being distributed to said end user.

19. A device for providing audio visual content, said method comprising:
means for stegographically embedding a watermark representing a redistribution authorization into digital content;
means for encrypting digital content;
means for loading said encrypted digital content, a decryption key and said redistribution authorization onto a secure digital storage module;
means for monitoring the integrity of said storage device and if the integrity of said secure, portable digital storage is breached, deleting said encryption key from said secure digital storage module.
means for associating said secure digital storage module with a content manager;
means for checking said redistribution authorization by said content manager and, if not valid, automatically deleting said content from said secure digital storage device;
means for decrypting, by said content manager, content selected by an end user; and
means for distributing, by said content manager, said decrypted, selected content to said end user.

20. The device of claim 19 wherein said secure digital storage module has a capacity of at least 500 GB and wherein said encrypted digital content comprises a plurality of digital files and each digital file has a distinct encryption key and further comprising means for stegographically embedding a watermark into said digital content by said content manager, subsequent to said decrypting and prior to said distributing.
